(19) United States
(12) Patent Application Publication
(10) Pub. No.: US 2006/0103945 A1
(43) Pub. Date: May 18, 2006

(54) Method for enhancing the light transmittance of a composite optical assembly and a composite optical assembly made by the same

(75) Inventor: Chi-shu Huang, Taichung (TW)

Correspondence Address: TROXELL LAW OFFICE PLLC, SUITE 1404, 5205 LEESBURG PIKE, FALLS CHURCH, VA, 22041, US

(73) Assignee: Asia Optical Co., Inc.

(21) Appl. No.: 11/269,731

(22) Filed: Nov. 9, 2005

(30) Foreign Application Priority Data
Nov. 16, 2004 (TW) 093135042

(51) Int. Cl. G02B 3/00

(52) U.S. Cl. 359/654

(57) ABSTRACT

A method for enhancing the light transmittance of a composite optical assembly includes the steps of: (a) providing a first optical element having a refractive index n1; (b) providing a second optical element having a refractive index n2; (c) forming a first optical thin film on a surface of the second optical element that faces the first optical element, the first optical thin film having a refractive index n3; (d) coating an adhesive layer on a surface of the first optical thin film or on a surface of the first optical element, the adhesive layer having a refractive index n4, and the refractive index n3 of the first optical thin film being an intermediate value between the refractive index n4 of the adhesive layer and the refractive index n2 of the second optical element; and (e) bonding the first and second optical elements together by the adhesive layer.

### BACKGROUND OF THE INVENTION

1. Field of the Invention

The present invention relates to a composite optical assembly, and more particularly to a method for enhancing light transmittance of a composite optical assembly and a composite optical assembly made by the same.

2. Description of the Prior Art

A composite optical assembly plays an important role in the field of optics, such as eyeglass lens, camera lens, and photoelectrical product.

U.S. Pat. No. 3,956,759 (hereinafter the '759 patent) discloses a cassette type single lens reflex camera, including a longitudinally extending zoom lens system and a replaceable film cassette disposed in opposite sides of the camera casing. The zoom lens system comprises a lens group consisting of a number of lens elements. The spatial relationship between the lens elements has a significant influence on the transmittance of light through the lens elements and determines, to a great extent, the camera performance.

U.S. Pat. No. 4,848,894 (hereinafter the '894 patent) discloses a contact lens with laser protection. The contact lens is made either with a laser-reflecting or absorbing layer embedded in a transparent optical lens material, or formed as a layer on the convex side of such a material.

U.S. Pat. No. 6,334,680 (hereinafter the '680 patent) discloses a polarized lens with oxide additive for reducing glare and improving color discrimination, including a lens wafer containing a rare earth oxide, a polarized filter for reducing glare and an anti-reflective layer minimizing ghost images.

As disclosed in the '680 patent, the anti-reflective layer is ordinarily applied on the front and back surfaces of an optical element and can increase the light transmittance of the optical element. Similarly, a solid-state image pickup device, disclosed in U.S. Pat. No. 6,614,479 (hereinafter the '479 patent), employs an in-layer lens. Two anti-reflective films are separately formed on opposite sides of the in-layer lens for improving the light transmittance.

Generally, several optical elements must be combined together to form one optical assembly often by means of adhesion, just as those disclosed in the '894 patent, the '759 patent, the '479 patent, and the '680 patent. However, due to the fact that a substantial difference in refractive index often exists between adjacent optical elements bonded together, and also due to the fact that the adhesive layer between adjacent optical elements has a certain refractive index, the light transmittance property of the optical assembly as a whole is not so good as the original light transmittance property of each optical element.

Hence, a method to overcome the above-mentioned disadvantages of the prior art will be described in detail in the following embodiments.

### SUMMARY OF THE INVENTION

Accordingly, an object of the present invention is to provide a method for enhancing the light transmittance of a composite optical assembly.

Another object of the present invention is to provide a composite optical assembly having at least two optical elements bonded together by an adhesive layer and a first optical thin film disposed between one optical element and the adhesive layer, thereby enhancing the whole light transmittance of the composite optical assembly.

To achieve the first object of the present invention, a method for enhancing the light transmittance of a composite optical assembly in accordance with the present invention is provided, comprising the steps of: (a) providing a first optical element having a refractive index n1; (b) providing a second optical element having a refractive index n2; (c) forming a first optical thin film having a refractive index n3 on a surface of the second optical element that faces the first optical element; (d) coating an adhesive layer having a refractive index n4 on a surface of the first optical thin film, the refractive index n3 of the first optical thin film being an intermediate value between the refractive index n4 of the adhesive layer and the refractive index n2 of the second optical element; and (e) bonding the first and second optical elements together by the adhesive layer.

The step (c) further comprises forming a second optical thin film having a refractive index n5 on a surface of the first optical element that faces the second optical element; and the adhesive layer of the step (d) is coated on the surface of either the first optical thin film or the second optical thin film.

To achieve the second object of the present invention, a composite optical assembly in accordance with the present invention comprises a first optical element, a second optical element, a first optical thin film formed on a surface of the second optical element that faces the first optical element, and an adhesive layer applied between the first optical element and the first optical thin film to bond the first and second optical elements together. The refractive indices of the first optical element, the adhesive layer, the first optical thin film and the second optical element are respectively n1, n4, n3 and n2, wherein the refractive index n3 of the first optical thin film is an intermediate value between the refractive index n4 of the adhesive layer and the refractive index n2 of the second optical element.

The composite optical assembly further comprises a second film having a refractive index n5 formed on a surface of the first optical element that is toward the second optical element, wherein the adhesive layer may be formed on the surface of the first optical thin film or the surface of the second optical thin film.

Relations among the refractive indices of the elements and films satisfy the conditions of n4<n3<n2 and n4<n5<n1, or condition of n1<n5<n4<n3<n2, or the conditions of n2<n3<n4 and n1<n5<n4.

The emphasis of the present invention lies in coating the first optical thin film on a surface of the second optical element, and the first optical thin film has a refractive index between the refractive indices of the second optical element and an adhesive layer that bonds the first and second optical elements together, thereby enhancing the light transmittance of the whole composite optical assembly.

### BRIEF DESCRIPTION OF THE DRAWINGS

The present invention may best be understood through the following description with reference to the accompanying drawings, in which:

FIG. 1 is a schematic view showing a composite optical assembly according to a first embodiment of the present invention; and

FIG. 2 is a schematic view showing a composite optical assembly according to a second embodiment of the present invention.

### DETAILED DESCRIPTION OF THE INVENTION

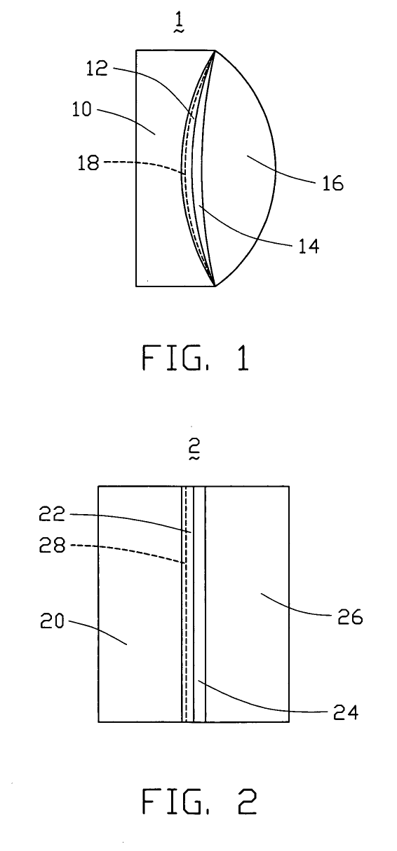

With reference to the drawings and in particular to FIG. 1, one example of a composite optical assembly 1 constructed in accordance with the present invention comprises a first optical element 10 and a second optical element 16 having a surface facing the first optical element 10, a first optical thin film 14 formed on the surface of the second optical element 16, and an adhesive layer 12 applied between the first optical element 10 and the first optical thin film 14 of the second optical element 16 to bond the first and second optical elements 10, 16 together. The refractive indices of the first optical element 10, the adhesive layer 12, the first optical thin film 14, and the second optical element 16 are n1, n4, n3 and n2, respectively. The refractive index n3 of the first optical thin film 14 is an intermediate value between the refractive index n4 of the adhesive layer 12 and the refractive index n2 of the second optical element 16.

The adhesive layer 12 is of such a cross-sectional configuration to closely mate with both the first optical element 10 and the first optical thin film 14. For example, if the adhesive layer 12 is applied to a surface of the first optical element 10 that faces the first optical thin film 14, the overall side contour of the combination of the adhesive layer 12 and the first optical element 10 is such as to closely match the contour of the first optical thin film 14 formed on the surface of the second optical element 16.

In another example shown in FIG. 2, a composite optical assembly 2 sequentially comprises, from left to right, a first optical element 20 having a refractive index n1, an adhesive layer 22 having a refractive index n4, a first optical thin film 24 having a refractive index n3, and a second optical element 26 having a refractive index n2. The difference between the first and second example of the composite optical assembly 1 and 2 resides in the surface contour of the first optical element 10 and 20 and the second optical element 16 and 26.

In the first example of FIG. 1, the surface contour of the surface (on which the adhesive layer 12 is applied) of the first optical element 10 is a curved surface, and the surface contour of the surface (on which the first optical thin film 14 is formed) of the second optical element 16 is also curved.

On the other hand, in the second example of FIG. 2, the surface contour of the surface (on which the adhesive layer 22 is applied) of the first optical element 20 is planar, and that of the surface (on which the first optical thin film 24 is formed) of the second optical element 26 is also planar.

The composite optical assembly 1 or 2 selectively comprises a second optical thin film 18 or 28 (dashed lines in FIGS. 1 and 2) having a refractive index n5, formed on the surface of the first optical element 10 or 20 and interposed between the first optical element 10 or 20 and the adhesive layer 12 or 22. The refractive index n5 of the second optical thin film 18 or 28 is between the refractive index n1 of the first optical element 10 or 20 and the refractive index n4 of the adhesive layer 12 or 22. The refractive indices n1, n2, n3, n4, and n5 satisfy the conditions of n4<n3<n2 and n4<n5<n1, or the condition of n1<n5<n4<n3<n2, or the conditions of n2<n3<n4 and n1<n5<n4.

The first optical thin film 14 or 24 coated on the surface of the second optical element 16 or 26 are formed by known vacuum vapor deposition methods or other coating methods to serve as an anti-reflection layer. The first optical element 10 or 20 and the second optical element 16 or 26 may be both lenses.

A practical example of the composite optical assembly 1 of the first embodiment, shown in FIG. 1, will be given to describe a method for enhancing the light transmittance of the composite optical assembly.

The method for enhancing the light transmittance of the composite optical assembly 1 in accordance with the present invention, comprises the steps of: (a) providing a first optical element 10 having a refractive index n1; (b) providing a second optical element 16 having a refractive index n2; (c) growing a first optical thin film 14 on one surface of the second optical element 16 that faces the first optical element 10, the first optical thin film 14 having a refractive index n3; (d) applying an adhesive layer 12 on the surface of the first optical thin film 14 or on one surface of the first optical element 10 that faces the second optical element 16, the adhesive layer 12 having a refractive index n4, and the refractive index n3 of the first optical thin film 14 being an intermediate value between the refractive index n4 of the adhesive layer 12 and the refractive index n2 of the second optical element 16, for example, n4<n3<n2 or n2<n3<n4; and (e) bonding the first and second optical elements 10 and 16 together by the adhesive layer 12.

In step (d), the surface contour formed after the adhesive layer 12 is applied to the surface of the first optical element 10 closely matches with that formed after the first optical thin film 14 is coated on the surface of the second optical element 16. Namely, the first and second optical elements 10 and 16 are bonded together entirely.

Step (c) further comprises coating a second film 18 on the surface of the first optical element 10 that faces the second optical element 16. The second optical thin film 18 has a refractive index n5. The adhesive layer 12 of step (d) may be coated on the surface of the first optical thin film 14 or the surface of the second optical thin film 18. Namely, the adhesive layer 12 is interposed between the first and second optical thin films 14, 18. The refractive index n5 of the second optical thin film 18 is an intermediate value between the refractive index n1 of the first optical element 10 and the refractive index n4 of the adhesive layer 12. The refractive indices n1, n2, n3, n4, and n5 satisfy the conditions of n4<n3<n2 and n4<n5<n1, or the condition of n1<n5<n4<n3<n2, or the conditions of n2<n3<n4 and n1<n5<n4.

At present, the refractive indices of the optical elements used in the market are mostly between 1.4 and 1.9, and the refractive indices of the adhesive layers for bonding the optical elements are ordinarily between 1.5 and 1.6. If the difference between the refractive indices of the optical elements and the adhesive layer is large, the composite optical assembly formed by bonding two optical elements having different refractive indices will have a large reflectance and the light transmittance thereof will be down.

The composite optical assembly according to the present invention employs a thin film (such as the first optical thin film 14) coated on the surface of one optical element (such as the second optical element 16). The refractive index of the thin film is an intermediate value between the refractive indices of the optical element and the adhesive layer, thereby reducing the reflectance between two adjacent optical elements and enhancing the light transmittance of the composite optical assembly.

Taking the composite optical assembly 1 shown in FIG. 1 as an example, the refractive indices of the first optical element 10, the adhesive layer 12, and the second optical element 16 are 1.43, 1.52, and 1.75, respectively.

If no coating is provided between the first and second optical elements 10, 16, the light transmittance of the whole composite optical assembly formed by directly bonding two optical elements 10, 16 together will be 99.412 percent, and the light transmittance is 99.907 percent when the light transmits through the contact interface between the first optical element 10 and the adhesive layer 12, and the light transmittance is 99.505 percent when the light transmits through the contact interface between the adhesive layer 12 and the second optical element 16. The value (99.412 percent) of light transmittance of the whole composite optical assembly is the product of 99.907 percent and 99.505 percent.

If the first optical thin film 14 having the refractive index of 1.6 is coated on the surface of the second optical element 16, the light transmittance of the whole composite optical assembly will be 99.614 percent, and the light transmittance is 99.907 percent when the light transmits through the contact interface between the first optical element 10 and the adhesive layer 12; the light transmittance is 99.934 percent when the light transmits through the contact interface between the adhesive layer 12 and the first optical thin film 14; and the light transmittance is 99.8 percent when the light transmits through the contact interface between the first optical thin film 14 and the second optical element 16. The value (99.614 percent) of light transmittance of the whole composite optical assembly is the product of 99.907 percent, 99.934 percent, and 99.8 percent. Because the thicknesses of the adhesive layer 12 and the first optical thin film 14 are both small, the light transmittance in the insides of the adhesive layer 12 and the first optical thin film 14 all can be regard as 100 percent.

In the first embodiment, the refractive index n3 of the first optical thin film 14 is an intermediate value between the refractive indices of the second optical element 16 and the adhesive layer 12, the refractive index n4 of the adhesive layer 12 is 1.52, and the refractive index n2 of the second optical element 16 is between 1.4 and 1.85. If n2 is smaller than 1.52, it does not need to coat the first optical thin film 14 on the second optical element 16 because the difference in refractive indices between the adhesive layer 12 and the second optical element 16 is sufficiently small. If n2 is larger than 1.52 or even as large as 1.6, the first optical thin film 14 having an intermediate refractive index n3 (that is 1.6) on the second optical element 16 is needed for enhancing light transmittance because the difference in refractive indices between the adhesive layer 12 and the second optical element 16 is so large that the light transmittance through the contact interface between the adhesive layer 12 and the second optical element 16 is significantly reduced.

The emphasis of the present invention resides in coating the first optical thin film 14 or 24 on the second optical element 16 or 26, and the refractive index of the first optical thin film 14 or 24 is between the refractive indices of the second optical element 16 or 26 and the adhesive layer 12 or 22, thereby enhancing the light transmittance of the whole composite optical assembly 1 or 2.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for enhancing light transmittance of a composite optical assembly, comprising the steps of:
(a) providing a first optical element having a refractive index n1, the first optical element having a first surface;
(b) providing a second optical element having a refractive index n2, the second optical element having a second surface facing the first surface of the first optical element;
(c) forming a first optical thin film on the second surface of the second optical element, the first optical thin film having a refractive index n3;
(d) selectively applying an adhesive layer on an outside surface of the first optical thin film or the first surface of the first optical thin film, the adhesive layer having a refractive index n4, the refractive index n3 of the first optical thin film being an intermediate value between the refractive index n4 of the adhesive layer and the refractive index n2 of the second optical element; and
(e) bonding the first and second optical elements together by the adhesive layer.

2. The method as claimed in claim 1, wherein n4<n3<n2.

3. The method as claimed in claim 1, wherein n2<n3<n4.

4. The method as claimed in claim 2, wherein n1<n4<n3<n2.

5. The method as claimed in claim 1, wherein step (c) further comprises a step of forming a second film having a refractive index n5 on the first surface of the first optical element and wherein the adhesive layer of step (d) is selectively coated on the outside surface of the first optical thin film or an outside surface of the second optical thin film.

6. The method as claimed in claim 5, wherein n4<n3<n2 and n4<n5<n1.

7. The method as claimed in claim 5, wherein n1<n5<n4<n3<n2.

8. The method as claimed in claim 5, wherein n2<n3<n4 and n1<n5<n4.

9. A composite optical assembly comprising a first optical element having a first surface, a second optical element having a second surface facing the first surface, a first optical thin film formed on the second surface of the second optical element, and an adhesive layer applied between the first surface of the first optical element and an outside surface of the first optical thin film to bond the second optical element to the first optical element, wherein the refractive indices of the first optical element, the adhesive layer, the first optical thin film and the second optical element are n1, n4, n3 and n2, respectively, the refractive index n3 of the first optical thin film being an intermediate value between the refractive index n4 of the adhesive layer and the refractive index n2 of the second optical element.

10. The composite optical assembly as claimed in claim 9, wherein n4<n3<n2.

11. The composite optical assembly as claimed in claim 10, wherein n1<n4<n3<n2.

12. The composite optical assembly as claimed in claim 9, wherein n2<n3<n4.

13. The composite optical assembly as claimed in claim 9 further comprising a second film having a refractive index n5 formed on the first surface of the first optical element, wherein the adhesive layer is selectively applied to an outside surface of the first optical thin film or an outside surface of the second optical thin film.

14. The composite optical assembly as claimed in claim 13, wherein n4<n3<n2 and n4<n5<n1.

15. The composite optical assembly as claimed in claim 13, wherein n1<n5<n4<n3<n2.

16. The composite optical assembly as claimed in claim 13, wherein n2<n3<n4 and n1<n5<n4.
